(19) United States
(12) Patent Application Publication
(10) Pub. No.: US 2007/0147486 A1
(43) Pub. Date: Jun. 28, 2007

(54) Signal processing within a wireless modem

(75) Inventors: Jonathan Labs, Montreal (CA); Stephane Gagnon, Montreal (CA); Pierre J. Lamoureux, St-Lazare (CA)

Correspondence Address: BERESKIN AND PARR, 40 KING STREET WEST, BOX 401, TORONTO, ON, M5H 3Y2, CA

(73) Assignee: WAVESAT, Dorval (CA)

(21) Appl. No.: 11/318,554

(22) Filed: Dec. 28, 2005

(51) Int. Cl. H04L 5/16

(52) U.S. Cl. 375/222

(57) ABSTRACT

There is provided a wireless modem PHY having a selectable IF signal format output, e.g. between baseband, complex IF and low IF.

### FIELD OF THE INVENTION

The invention relates generally to the field of wireless communication systems, and more specifically to signal processing within wireless modems.

### BACKGROUND OF THE INVENTION

Currently there are many types of network access services that may be used. Cable and DSL broadband access services are two services whose popularity has increased greatly over the past few years, and as a result have enabled a great number of people and communities across the world to receive Internet access. However, even as broadband systems have gained in popularity, there remain a large number of areas throughout the world that are unable to access broadband connectivity. DSL connectivity generally requires a central office, and DSL connections may generally only be made within short distances from the central office switch (generally, less than 4 miles).

Due to the limitations associated with cable and DSL, various wireless access methods have been proposed and developed in an attempt to provide network access services to a greater number of people.

Wireless access systems require the use of wireless modems, which are connected to a computing device. Many wireless network access technologies are also faced with the same or similar limitations that are faced by wired technologies in relation to both performance or capacity. For example, two common limitations faced by both include the distance from the ADSL (asymmetric digital subscriber lines) or Line of Site (LOS) requirements. Often such limitations may be overcome through use and implementations of other equipment, however, this directly results in increased costs.

Wireless modems (also referred to as RF modems) are generally comprised of an RF transceiver, a baseband chip which is used to modulate and demodulate received signals, a CPU, and interface that allows for connectivity to the local host machine, and a memory store. The components of the modem operate so as to receive and transmit signals. When receiving an RF signal, the received signal is processed to determine the information that is encapsulated within. Received RF signals generally are encapsulated with data that is not to be construed as part of the information transmittal, and therefore such data (i.e. packet headers) etc. needs to be removed, and such removal of data is performed by the processor associated with the modem.

Many wireless network access technologies are faced however, with similar limitations to those that are faced by wireless technologies in relation to both performance and capacity. One standard that has been proposed and developed to overcome the limitations that are associated with other wired and wireless access methods is WiMAX. WiMAX is a broadband wireless technology that is able to cover a large geographic area, one that is upto 50 KM in radius and is able to deliver bandwidth to users of upto 72 Mbps. Other wireless technologies generally are able to only provide Line-of-Site (LOS) coverage, however, WiMAX due to its use of OFDM (Orthogonal Frequency Division Multiplexing) is able to provide connectivity access upto 15 KM away in Non-Line of Sign (NLOS) conditions, and in LOS conditions provides transmissions in the 50 KM ranges.

### SUMMARY OF THE INVENTION

Therefore, there is a need for wireless modems that are able to operate in multiple modes and process and transmit signals of various types, as well being able to overcome limitations associated with the geographic coverage areas that limit most wireless modems.

In some embodiments of the invention, there is provided a wireless modem PHY having a selectable IF signal format output, e.g. between baseband, complex IF and low IF.

In other embodiments of the invention, complex IF is used in a wireless modem to provide a separation between a desired signal and the image signal that is created.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of the components of a wireless modem;

FIG. 2 is a block diagram of the modules contained within a PHY chip of a wireless modem;

FIG. 3 is a block diagram of the components of the conversion module shown in FIG. 2;

FIG. 4A is a frequency domain graph of a baseband input signal;

FIG. 4B is a frequency domain graph of baseband output signal;

FIG. 5A is a frequency domain graph of a complex IF input signal;

FIG. 5B is a frequency domain graph of a complex IF output signal;

FIG. 6A is a frequency domain graph of a low IF input signal; and

FIG. 6B is a frequency domain graph of a low IF output signal.

### DETAILED DESCRIPTION OF THE INVENTION

The preferred embodiment of the present invention is described herein, by reference to the operation of a wireless modem. For purposes of example, the wireless modem is described generally, as one which may implement the 802.16-2004 wireless protocol. It will however, be understood that the wireless modem described as the subject of this invention may be any type of wireless modem, that is designed and operated according to any other protocol.

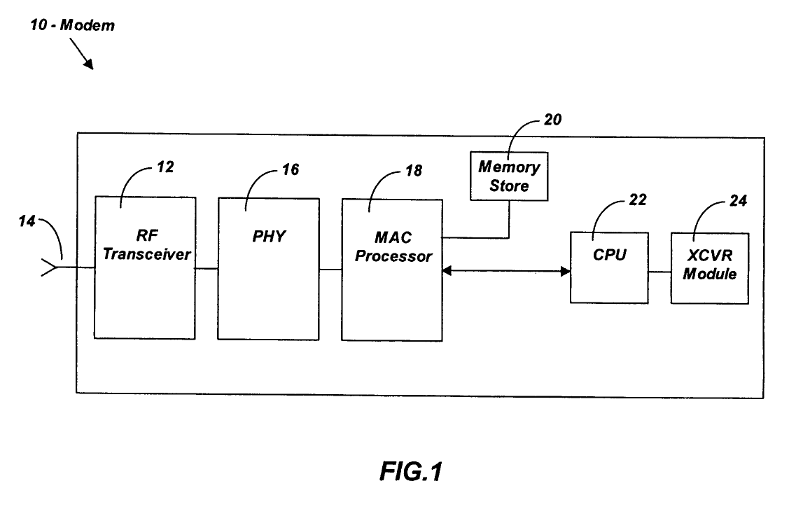

Reference is now made to FIG. 1, where a wireless modem 10 and its constituent components are shown in one embodiment. The wireless modem 10 may be any type of modem that allows for RF communication, however, as stated above for purposes of example, the wireless modem 10 is shown as a modem that implements the WiMAX protocol. The wireless modem 10 is comprised of a radio frequency (RF) transceiver 12, an antenna 14, a PHY chip 16, a media access control (MAC) processor 18, a memory store 20, a central processing unit 22, and an Ethernet controller module 24.

The RF transceiver 12 facilitates wireless data reception and transmission from and to the wireless modem 10. RF is used to refer to the electromagnetic waves that are used in radio communication. Radio waves are classified according to their respective frequencies. Radio frequencies may range from a very low frequency (VLF), which has a range of 10 to 30 kHz, to an extremely high frequency (EHF), which has a range of 30 to 300 GHz. The RF transceiver is the source of the RF energy that the antenna 14 transmits and receives. The antenna 14 when transmitting a signal receives RF current that is supplied and generates an electromagnetic field that is used to transmit the signal. When an RF current is supplied to an antenna, an electromagnetic field is created.

The physical layer chip (PHY) 16 is used to implement the appropriate wireless transmission and reception protocol. The PHY chip 16 is used to carry out signal processing functions, including the selection and generation of different signal types and the subsequent encoding of signals for transmission. With respect to receipt of signals, the PHY chip 16 is used to decode the transmission that is received as well as convert the received signal into a format (mode) that is required for processing. The PHY chip 16 modulates and demodulates the signals according to a selection that is made. The PHY chip 16 allows for the implementation of the protocol used to implement broadband wireless access. The PHY chip 16 is used to implement Orthogonal Frequency Division Multiplexing, both upstream and downstream. The components of the PHY chip 16 are illustrated in further detail below.

The media access control (MAC) processor 18 is a low level processor that is used to perform timing critical operations for the central processing unit and to serve as an interface between the PHY chip 16 and the central processing unit 20. The media access control processor 18 provides information to the central processing unit 20, including but not limited to, all the data, transmission statistics, and control information from a base station. The MAC processor 18 is housed within an FPGA. The MAC processor 18 is responsible for the determination, insertion and removal of message fields associated with the appropriate transmission protocol.

The memory store 20 associated with the FPGA is used to store instructions and data, and may include flash and SDRAM memory.

The central processing unit 22 is used to execute instructions that are provided to it by other components of the wireless modem 10.

The Ethernet controller module 24 is used to transmit data via a wired means (i.e. Ethernet) to other devices which may rely on the transmission and reception capabilities of the modem 10.

The PHY chip 16 also controls attributes of the RF section 12. In some embodiments, an interface between PHY 16 and RF transceiver 12 is included, as is described in greater detail in commonly owned co-pending US patent application filed herewith bearing the title “Wireless Modem” and agent docket number 15031-6, the specification of which is incorporated herein by reference.

The MAC uses a DMA connection to transfer data to the CPU. In some embodiments, the lower level MAC is provided in hardware and transfers data to the higher level MAC provided by software executed by the CPU. In these embodiments, a DMA interface is provided to connect the MAC over the computer bus to the high level MAC, as described in greater detail in commonly owned co-pending US patent application filed herewith bearing the title “Wireless Modem” and agent docket number 15031-4, the specification of which is incorporated herein by reference.

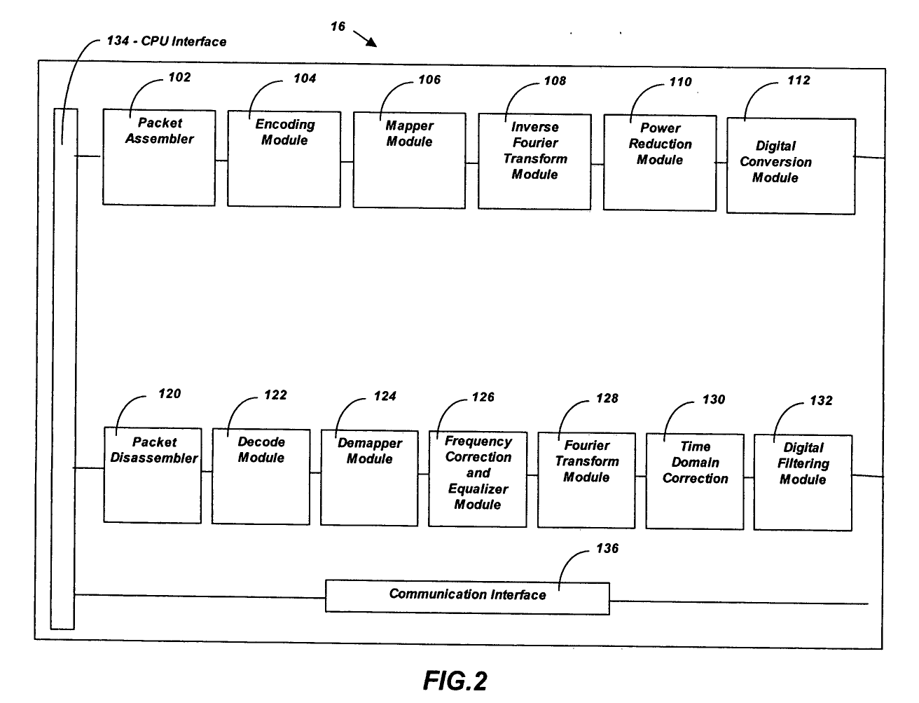

Reference is now made to FIG. 2, where the PHY chip 16 and its method of operation is described in further detail. One example of the specification of the PHY chip 16 is now provided. The specifications of the PHY chip 16 that are described herein should not be taken to be limiting, and are provided for purposes of example, based on a chip that has been designed to implement the WiMax wireless transmission protocol. The PHY chip 16 is based on OFDM modulation, both for upstream and downstream data flows. The PHY chip 16 is able to have its components operate on a frequency band between 2 and 11 GHZ, and may operate on any one of the following bandwidths 1.75 MHz, 3.5 MHz, 7 MHz, and 10 MHz.

As transmission from the PHY chip 16 is based on OFDM, frame descriptors are used to convey information about the data being transmitted, and the frame descriptors must specify how the frames of data should be encoded and modulated. The frame descriptors provide information to the PHY chip 16 as to some of the actions that are to be performed by the PHY chip 16 on a frame by frame basis.

The PHY chip 16 operates so as to receive or transmit signals of varying modes. The PHY chip 16 is able to receive and process signals, along with transmit signals which may be in different modes, including baseband I/Q, complex IF and low IF. The selection of the mode which the signals are to be transmitted in or processed in, if they are received signals, is based on a selection that is transmitted to the PHY chip 16. When the modem 10 is to transmit data, the packet assembler module 102 is used to assemble the packets of information comprising the signal that is to be transmitted. The encoding module 104 then receives the packets as assembled from the packet assembler module 102 and encodes them according to the appropriate encoding scheme that is to be employed. Upon the signal being encoded, the mapper module 106 receives the signal and maps the incoming data to a set of carriers by employing a BPSK, QPSK, QAM-16, or QAM-32 modulation technique respectively.

The Fourier transform module 108 is used to apply the appropriate Fourier transform to the signal that is to be transmitted. The power reduction module 110 is a peak to average power ratio (PAPR) reduction module, that reduces the ratio between the peak power and the average power. It is beneficial to the reduce the peak to average power ratio as a high peak to average power ratio results in the necessity of a high cost amplifier in the RF module, and more specifically in the RF transmitter.

The description of the general components involved in the receipt of a transmission in the PHY chip 16 will now be described with reference to the general functionality applied within the module.

The digital filtering module 132 performs an anti-aliasing filter and may perform digital down-conversion to baseband from an IF or Complex IF signal if required. The digital filtering module also performs an up-sampling function to a 40 MHz sample rate. The time domain correction module 130 corrects the incoming data stream for mismatches between the sampling clock of the receiving and transmitting modems. The Fourier Transform module 128 transforms the incoming data stream from the time domain to the frequency domain. The frequency correction and equalizer module 126 then receives the input after the Fourier Transform module 128 has operated upon the transmission and performs the required correction and equalizing to recover the signals as they were transmitted from the Base Station. The demapper module 124 transfers the data of each modulator sub carrier into a serial data stream. The decoder module 122 is used to decode the transmission based on a Forward Error Correction encoding techniques that may have been used. The packet disassembler module 120 receives the packets that comprise the transmission being received by the PHY chip 16, and disassembles the respective packets with respect to removing and stripping the packets of any header information and other information that has been employed in the transmission.

The CPU interface 134 is the means employed for the PHY chip to be able to interface with the CPU and transmit data to, and receive data from, the CPU. The communication interface 136 allows other components of the modem 10 (i.e. the MAC processor 18) to interface with the PHY chip 16.

The operation of the digital conversion module 112 will now be further described. The digital conversion module 112 is able to generate and process a plurality of signal types. In one: embodiment the PHY chip 16 is able to modulate transmitted data and demodulate received data that is of the base-band I/Q type, the complex IF type and the low IF type. I/Q data is used to show the changes in magnitude and phase of a sine wave. As the changes in magnitude and phase of a sine wave are made in an orderly and predetermined fashion, this magnitude and phase change information may then be used to encode or modulate information. Modulation refers to changing a higher frequency signal in proportion to a lower frequency signal. The higher frequency signal is generally referred to as the carrier signal, and the lower frequency signal is generally referred to as the message signal, or modulating signal. The digital conversion module 112 is comprised of a plurality of sub modules, which are used to generate or process the signal. The digital conversion module 112 as it is part of the PHY chip 16, is controlled through signal lines which are implemented as registers which specify which type of signal is to be input, and also which type of signal is to be output.

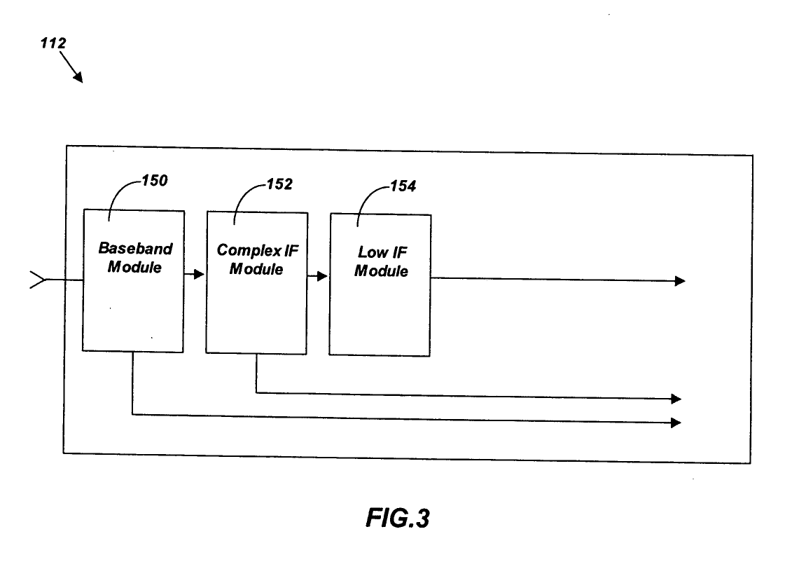

Reference is now made to FIG. 3, where the constituent components of the digital conversion module 112 are illustrated. FIG. 3 describes the general relationship between the various modules that are used when the PHY chip 16 is to generate a signal for transmission purposes. Specifically, the digital conversion module 112 further comprises a baseband module 150, a complex IF module 152 and a low IF module 154. A selector switch (not shown in FIG. 3) is included to selectively output the desired IF signal format.

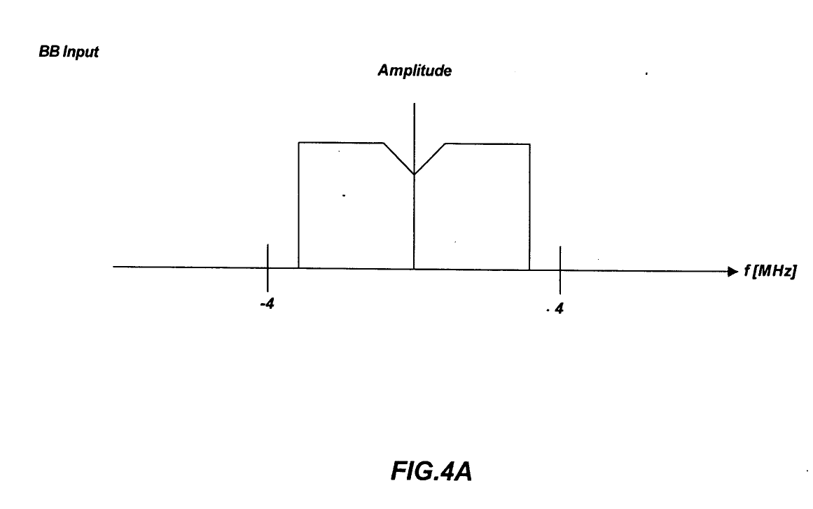

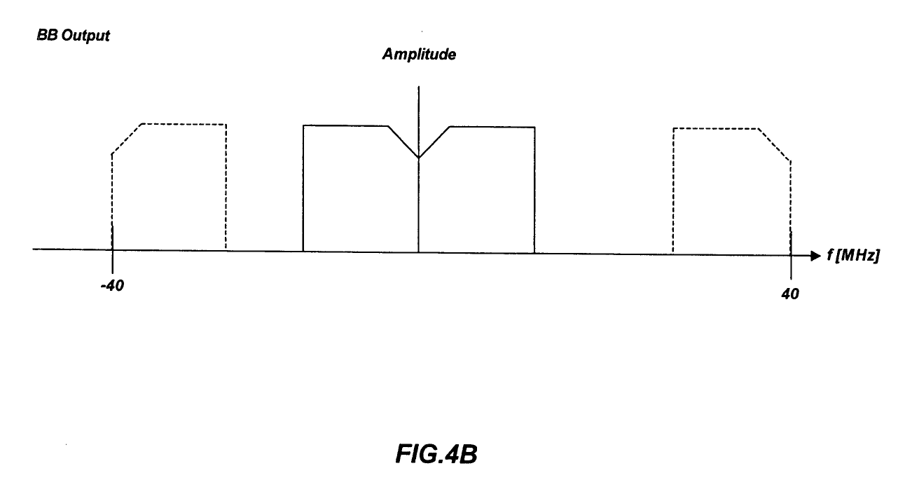

Reference is now made to FIG. 3, where the components of the module 112 are described in further detail. All signals are generally comprised of different frequencies that are all brought together. Those parts of the signal that are at low frequencies are modulated up to higher frequencies, as some communication channels generally will not allow the low frequency components which are generally referred to as the baseband signals to be transmitted through the respective communication channel. Baseband signals however are used in different applications, particularly in radios that are of a single state direct up conversion variety where direct conversion from a baseband signal to an RF signal will take place. In order to generate a baseband I/Q signal, the baseband module 150 receives as input a baseband complex signal for which the sampling rate is known. Specifically, the sampling rate for purposes of this embodiment with respect to a PHY chip 16 is either one of 2, 4, 8, or 11.52 MHz, respectively. The baseband IQ module 150 generates a baseband complex output signal that is oversampled, such that its sampling rate is 40 MHZ. Upon the output signal, which has been oversampled to a rate of 40 MHz being generated, a filtering process is undertaken so that unwanted images and noise are removed from the signal. Reference is now made to FIG. 4A where the frequency domain graph of the signal that is input to the baseband I/Q module 150 is shown. FIG. 4B illustrates the output signal that is generated from the baseband I/Q module 150.

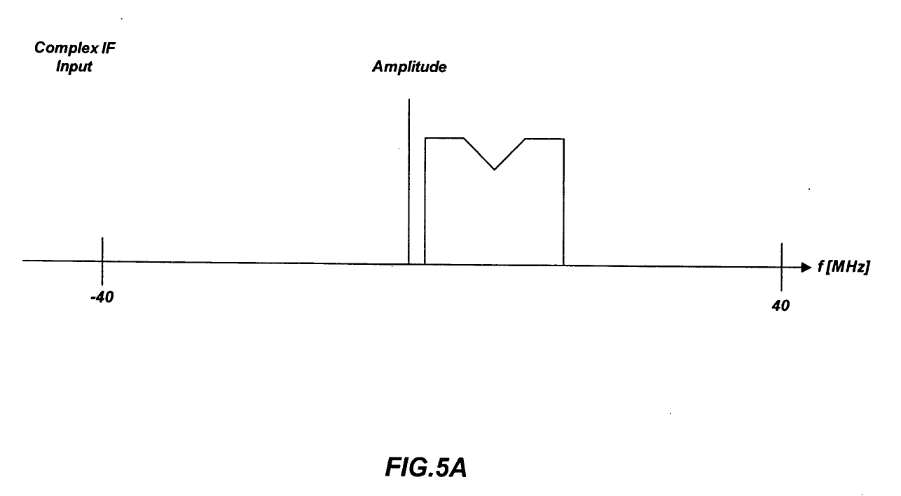

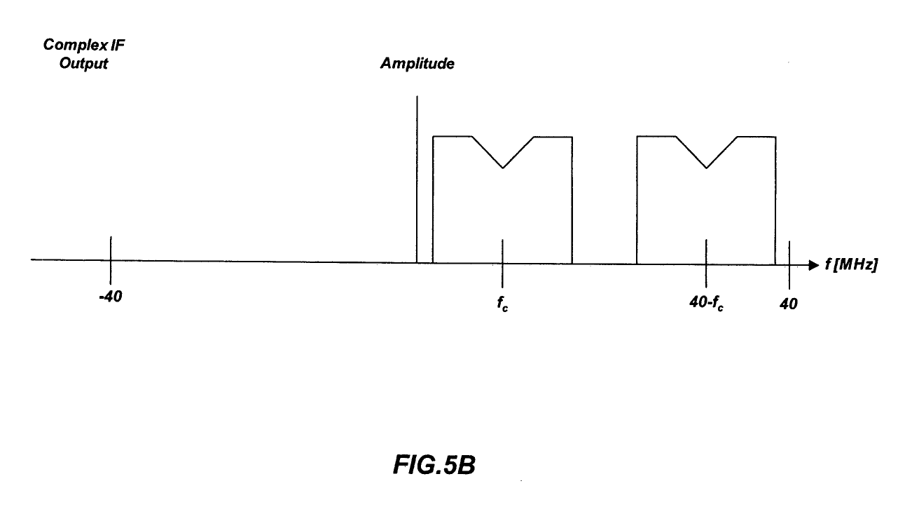

Complex signals have the advantage of providing a separation between a desired signal and the image signal that is created. An example of a situation where a complex signal would be used, is when adjacent signals in a super heterodyne receiver are to be rejected. As an example, if any desired signal is at a certain frequency f_{c} then as a result of the I and Q imbalance a frequency inverted image which has a center frequency at −f_{c} is created. Reference is made to FIGS. 5A and 5B, where the frequency domain graph for both the input signal to the complex IF module 152 and the output of the complex IF signal, are shown respectively. The complex IF module 152 operates under the assumption that the input signal it receives is a complex signal at a specified sampling rate. The complex IF module 152 operates on the input signal so as to translate the signal to the desired intermediate frequency. The desired intermediate frequency that is to be used to generate the output signal is specified through control information that is received at the digital conversion module. The generation of the output signal is performed by applying a complex exponential to the time domain sample. The frequency translation that is desired is represented by ω_{c}. The generation of the output complex IF signal is performed through application of the following equation:
x(n)·e^{(iΔω}^{_{c}}^{nΔt)} (1)

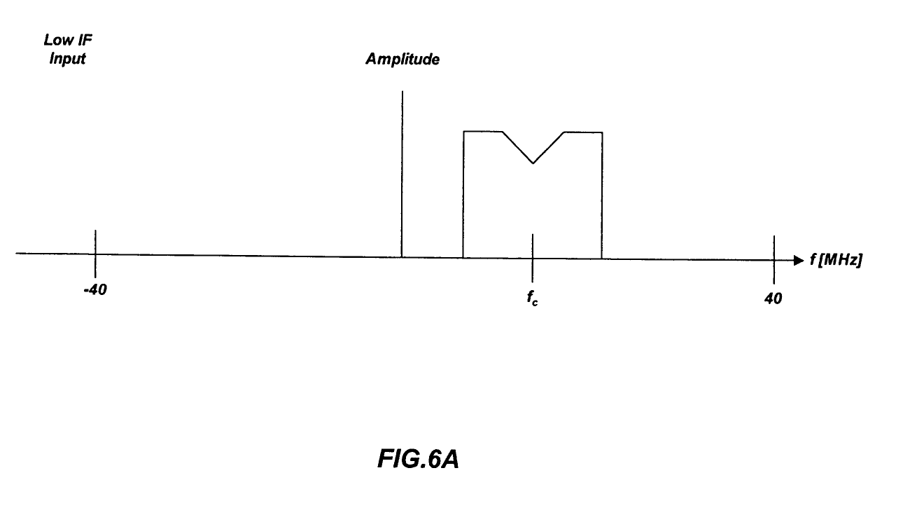

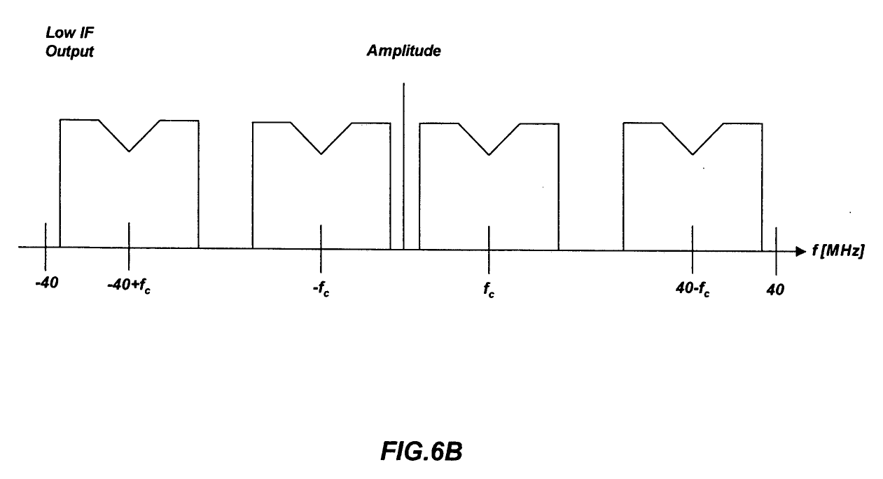

Reference is now made to FIGS. 6A and 6B, where the input and output signals, received and generated, respectively, by the low IF module 154 are shown. The low IF module 154 is used to generate a real-valued signal at the same IF based on the input signal. There are advantages to generating and using a low IF signal that is real valued as there is no I/Q imbalance as 10 imbalance provides for a degraded signal. If there is I/Q imbalance associated with the out low IF signal, it may be removed by digital means

The output signal generated by the low IF module is the real valued signal of the complex non-zero IF signal that is input. Specifically, if x(n) is the nth sample in the series of time domain signals, the low IF module generates the output signal based on the following equation:
Re{x(n)} (2)

The application of the equation results in the extraction of the real aspect of a complex signal at a frequency f_{c} so as to create an inverted image frequency at −f_{c.}

The invention has been described with regard to a number of embodiments. However, it will be understood by persons skilled in the art that other variants and modifications may be made without departing from the scope of the invention as defined in the claims appended hereto.

1. A wireless modem comprising:
an RF module adapted to be connected to an antenna, comprising an intermediate frequency (IF) input and an intermediate frequency (IF) output; and
a physical layer (PHY) device for modulating and demodulating a plurality of different format signals, wherein the plurality of different format signals include a baseband I/Q signal, a complex IF signal, and a real IF signal, the PHY device comprising a selection input for causing a selected one of said plurality of different format signals to be output to said IF input of said RF module.
